(19) United States
(12) Patent Application Publication
(10) Pub. No.: US 2024/0153247 A1
(43) Pub. Date: May 9, 2024

(54) AUTOMATIC DATA GENERATION

(71) Applicant: Lemon Inc., Grand Cayman (KY)

(72) Inventors: Yifan Zhang, Singapore (SG); Daquan Zhou, Los Angeles, CA (US); Kai Wang, Singapore (SG); Jiashi Feng, Singapore (SG)

(21) Appl. No.: 18/053,851

(22) Filed: Nov. 9, 2022

(51) Int. Cl. G06V 10/774; G06V 10/40; G06V 10/764; G06V 10/82

(52) U.S. Cl. CPC G06V 10/774; G06V 10/40; G06V 10/764; G06V 10/82; G06V 20/52

(57) ABSTRACT

Automatic data generation includes extracting latent features from an input image, adding a perturbation to the latent features, applying the perturbed latent features to a pre-trained generative model, and training an image generator with images output from the generative model.

### TECHNICAL FIELD

The embodiments described herein pertain generally to the provision of training data to increase the power of a Deep Neural Network (DNN).

### BACKGROUND

Deep neural networks (DNN) require significant amounts of training data for optimal or near-optimal performance. However, collecting large-scale data sets is expensive and time consuming.

### SUMMARY

In one example embodiment, a media platform includes an image extractor to extract latent features and at least one class from an input image, a generative model to generate synthetic images based on the extracted latent features with the synthetic images having the same class as the input image, a decoder to train a deep neural network (DNN) image generating model using the generated synthetic images, and a DNN image generator to generate images utilizing the DNN image generating model.

In accordance with at least one other example embodiment, a method of automatic data generation includes extracting latent features and at least one classification from an input image, inputting the extracted latent features into a generative model decoder, and generating synthetic images using a large-scale generative model.

In accordance with at least one other example embodiment, a non-volatile computer-readable medium has computer-executable instructions stored thereon that, upon execution, cause one or more processors to perform operations that include extracting latent features and at least one classification from an input image, adding a perturbation to the latent features, decoding the perturbed latent features to a pre-trained generative model, and training a deep neural network (DNN) image generator with the decoded images.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a system in which automatic data generation may be implemented, arranged in accordance with at least some embodiments described and recited herein;

FIG. 2 is a schematic depiction of a portion of a media platform, arranged in accordance with at least some embodiments of automatic data generation described and recited herein;

FIG. 3 shows an example processing flow for implementation of automatic data generation, in accordance with at least some embodiments described and recited herein;

FIG. 4 shows an illustrative computing embodiment, in which any of the processes and sub-processes for automatic data generation may be implemented as executable instructions stored on a non-volatile computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described and recited herein, as well as illustrated in the drawings, may be arranged, substituted, combined, separated, and designed in a wide variety of different configurations, all of which are explicitly contemplated herein.

Additionally, portions of the present disclosure may be described herein in terms of functional block components and various processing steps. It should be appreciated that such functional blocks may be realized by any number of hardware and/or software components configured to perform the specified functions.

In the present description and recitation, the following terms may be used, in addition to their accepted meaning, as follows.

Artificial intelligence, alternatively referenced herein as “AI,” may refer to a learned or trained computer or processor-related technology by which decisions and/or actions are autonomously made, in place of human intervention. AI refers to software, i.e., algorithms and/or programs, hardware or firmware, or any combination thereof that supports machine learning, natural language understanding, natural language processing, speech recognition, computer vision, etc. Also included among the range of AI functions and capabilities, and pertinent to the embodiments disclosed, recited, and suggested herein, image generation and model training.

An engine or generator, as disclosed, recited, and/or suggested herein, may refer to a type of software, firmware, hardware, or any combination thereof, that facilitates generation of source code or markup to produce elements that begin another process. In addition, or alternatively, an engine or generator may facilitate automated processes, in which various software elements interact to produce an intended product, whether physical or virtual based on natural language descriptions, inputs, or other prompts. In accordance with known AI technologies, the AI engines or generators disclosed, recited, and/or suggested herein are trained in accordance with either unimodal or multimodal training models.

Text-to-image model image generation, in accordance with computer vision and image processing, may refer to generation or production of an image, by a machine learning model, based on a natural language description input. Training a text-to-image model requires a dataset of images paired with text captions, e.g., classifications.

Latent features, in accordance with computer vision and image processing, may refer to feature vectors extracted by an encoder of a generative model, i.e., features that are extracted from an input dataset that correspond to any one of the input captions, e.g., classifications.

Object detection, in accordance with computer vision and image processing, may refer to technologies for detecting instances of semantic objects of a certain class in digital images and/or videos. Non-limiting contextual applications for object detection may include image retrieval, video surveillance, device security, etc.

A social media application, as disclosed and recited herein, may refer to an on-line application that allows account-holding users to interact with one another using various media and on varying scales, with such interaction including creating and/or sharing media content. As disclosed and recited herein, a user device may have an instance of social media application account stored locally or may access the user's account via a web-based version of the particular social media application.

A platform, e.g., a social media platform, as disclosed and recited herein, may refer to an application on which algorithms and/or programs enabling execution or implementation of a collection of communication-based or media-sharing technologies may be hosted. Further, any algorithm or program described, recited, or suggested herein may be executed by one or more processors hosted on such a platform. Non-limiting examples of such technologies may include the creation, sharing, and/or storage of multi-media offerings.

Media, or multi-media, offerings or experiences, as disclosed and recited herein, may include but not be limited to recorded or live transmittable content including text, audio, images, animations, video, etc. In addition, such offerings or experiences may include, but again not be limited to, interactive augmented reality (AR) and/or interactive virtual reality (VR) experiences.

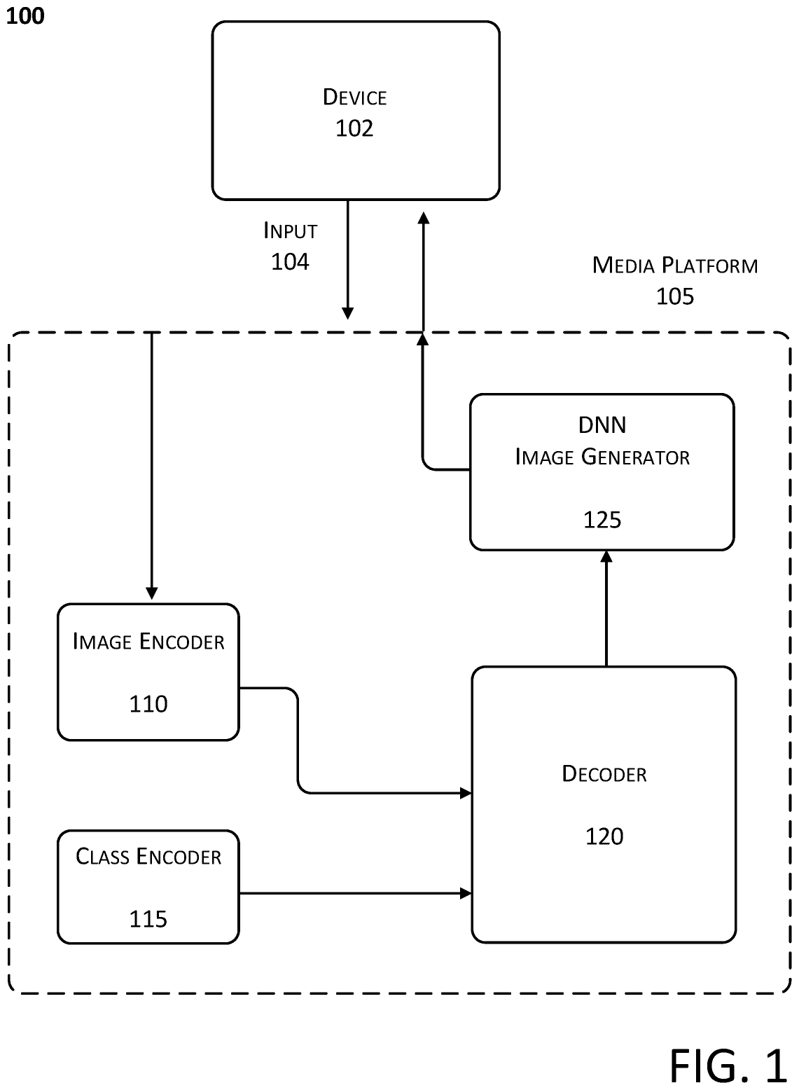

FIG. 1 shows a system in which automatic data generation may be implemented, arranged in accordance with at least some embodiments described and recited herein. As depicted, system 100 includes input device 102 and media platform 105. Media platform 105 utilizes a generative model that includes, at least, image encoder 110, class encoder 115, decoder 120, and image generator 125. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof.

Input device 102 may refer to one or more embodiments of a classical computing device that may be, or include, a classical computer, processing device, a microprocessor, a microcontroller, a digital signal processor, or any combination thereof. Device 102 may be one of various electronic devices, or a combination thereof, having one or more image and/or video capturing components, i.e., camera and/or video recorder, display screens with audio and/or video inputs/outputs and that support the providing of and consumption of content relative to a media platform. The various electronic devices may include but not be limited to a smartphone, a tablet computer, a laptop computer, a desktop computer, a security/surveillance device, an e-book reader, an MP3 (moving picture experts group audio layer Ill) player, an MP4 player, and/or any other suitable electronic devices. Non-limiting examples of input device 102 as a security device may include a video doorbell, a vehicle dash-cam, a security camera (whether constantly active or motion-activated), etc. Additional non-limiting examples of input device 102 may include a database, local server, cloud-based service, a virtual reality (VR) and/or augmented reality (AR) servers, etc. Further, any algorithm or program described, recited, or suggested herein may be executed by one or more processors hosted on input device 102.

Input 104, in accordance with at least some of the embodiments disclosed and recited herein, may refer to digital images, digital video, text, and/or audio that may be input manually or in an automated manner to an appropriate input interface. Input 104 may be transmitted or otherwise communicated from input device 102 to a receiving component corresponding to media platform 105 via a wired or wireless network. Such network may be regarded as a medium that is provided as a bidirectional communications link between media platform 105 and input device 102. The network may include the Internet, a local area network (LAN), a wide area network (WAN), a local interconnect network (LIN), a localized cloud, etc.

Media platform 105 may refer to, e.g., a social media platform and/or a security/surveillance platform, for which is implemented an application on which algorithms and/or programs enabling execution of a collection of communication-based or media-sharing technologies may be hosted. Such technologies include monitoring, creating, sharing, and/or storing multi-media offerings.

Image encoder 110 and class encoder 115 may refer to one or more components or modules that are designed, programmed, or otherwise configured to receive dataset (x, y) as input 104 that includes an image or images x and corresponding classifications y from input device 102. A non-limiting example of an encoder that incorporates the functionality of both image encoder 110 and class encoder 115 is a text-visual contrastive pre-training model (CLIP), which may be trained by contrastive learning on a large-scale image-to-text dataset to prepare a prior generative model.

Image encoder 110 may be designed, programmed, or otherwise trained to iteratively extract, from dataset (x, y) input 104, feature vectors corresponding to the latent features f(x) of dataset input 104 in accordance with known encoding technologies. Non-limiting examples of extracted features may include persons (intact or in part), animals, objects, edges, points, boundaries, curves, shapes, etc. Such features may be regarded as high-level content of the input images, typically corresponding to semantics of the respective images.

Class encoder 115 may be designed, programmed, or otherwise trained to iteratively extract, from dataset input 104, classifications y from dataset input 104, in accordance with known encoding technologies.

In accordance with zero-shot classification abilities of, e.g., a CLIP encoder (image encoder 110 and class encoder 115), the class name y of sample x is encoded as f(y) to be the zero-shot classifier of class y. Zero-shot classification refers to a classification model that is not trained on the annotated target image data, but rather predicts class labels of samples in a respective dataset input 104. That is, zero-shot recognition refers to the ability of, e.g., a CLIP encoder to predict the class of samples in a respective dataset when it is not trained on the labeled target dataset. Thus, for at least the non-limiting example embodiments pertaining to automatic data generation described, recited, and suggested herein, zero-shot predictions are applied to input image x and subsequent intermediate or output images to derive guidance for optimizing the latent features.

Decoder 120 may refer to a pre-trained diffusion model that is designed, programmed, or otherwise trained to implement portions of the Guided Imagination Framework (GIF) for dataset expansion that begins with encoders 110 and 115. Decoder 120 optimizes the latent features of dataset (x, y) input 104 based on guidance derived by the zero-shot predictions applied to input image x and the subsequent intermediate images. For the diffusion model, the zero-shot prediction is calculated as s=w(f), with w being the zero-shot classifier and f being an extracted feature vector.

At or by decoder 120, the pre-trained diffusion model causes the latent features, i.e., extracted feature vectors, to be repeated K times, K being the expansion ratio. For each latent feature, a residual multiplicative perturbation is injected with a randomly initialized noise, which is a random noise sampled from a Gaussian distribution, and bias, with both the noise and bias being unique to the respective latent feature, to thereby perturb the feature vector from f to f′. Based on f′, decoder 120 could generate new images.

However, in order for new images to be generated by decoder 120 to be class consistent with y of input (x, y) of input 104, the randomly initialized noise and bias are optimized over the latent features as a function of class consistency, entropy difference, and diversity. That is, in accordance with the embodiments of automatic data generation described, recited, and suggested herein, decoder 120 is to leverage the zero-shot prediction ability of, e.g., a CLIP encoder to implement informative criteria, i.e., guidance, for the extracted latent features, and the class prediction vector is thus calculated as s′=w(f′).

The guidance enforced on the noise and bias includes zero-shot prediction consistency, entropy maximization, and diversity promotion. Prediction consistency refers to the zero-shot predictions provided by the one or more encoders for input image x and the subsequent intermediate or output images being the same to thereby ensure that class semantics of the output image as the same as those of input image x. Entropy maximization refers to the subsequent intermediate or output images having a larger zero-shot prediction entropy than that of input image x. That is, any difference between the prediction entropy of input image x and any subsequent intermediate or output images is to be maximized. Diversity promotion refers to the subsequent intermediate or output images being diversified without excessive similarity or repetition.

After the noise and bias are optimized and injected onto the extracted latent features x, effectively producing a set of new latent features x′, decoder 120 produces synthetic images 230 on a scale of expansion ratio K.

Image generator 125 may refer to a DNN image generating model, which is to generate new images based on training that is based on dataset (x, y) input 104 that is expanded by a factor of K, input from decoder 120.

The generative model that is referenced, described, and recited herein, pertains to a guided imagination framework (GIF) for dataset expansion, by guiding a method built on pre-trained generative models. Thus, given seed image x from target dataset (x, y), its latent feature f(x) is extracted utilizing the encoder of a pre-trained model, e.g., the CLIP image encoder f_{CLIP-I}. Different from data augmentation that imposes variation over the raw RGB images, this model optimizes variation over sample latent features. Thus, varied latent features are able to maintain sample class semantics while providing additional new information for model training.

In accordance with non-limiting example embodiments for the framework, DALL-E2 may be utilized as the prior generative model.

DALL-E2 may be built by adopting CLIP image/text encoders f_{CLIP-I} and f_{CLIP-T} as image encoder 110 and text encoder 115, and using a pre-trained diffusion model G as its decoder.

To create a set of new images x′ from the seed image x, GIF first repeats its latent feature f=f_{CLIP-I}(x) for K times, with K being the expansion ratio. For each latent feature, perturbation is injected over the latent feature f with randomly initialized noise z˜U(0, 1) and bias b˜N(0, 1). To prevent out-of-control imagination, residual multiplicative perturbation is conducted on latent feature f and an E-ball constraint is enforced on the perturbation as follows:

f′=Pf,ϵ((1+z)f+b) (1)
with P_{f,ϵ}(⋅) referring to the projection of the perturbed feature f′ to the E-ball of the original latent feature, i.e., //f′−f//_{∞}≤ε. Each latent feature has unique and/or independent z and b.
   GIF optimizes z and b over the latent feature space as follows:

z′,b′←arg_{z,b}max

S_{con}+Sₑₙₜ+S_{div} (2)

S_{con}, Sₑₙₜ, and S_{div} respectively correspond to class consistency, entropy difference and diversity, respectively. To compute these objectives, the zero-shot classification abilities of CLIP are leveraged. Specifically, f_{CLIP-T} is utilized to encode class name y corresponding to image x of input dataset sample (x, y) and utilize embedding w_{y}=f_{CLIP-T}(y) as the zero-shot classifier of class y.

Each latent feature f(x) may be classified according to its cosine similarity to w_{y}, i.e., the affinity score of x belonging to class y is s_{y}=cos(f(x),w_{y}), which forms classification prediction vector s=[s₁, . . . , s_{C}] for C classes of the target dataset.

The prediction of the perturbed feature s′ can be obtained in the same way.

Prediction consistency S_{con} promotes consistency between the predicted classification scores on s and s′, so S_{con}=s′ᵢ, where i=argmax(s) is the predicted class of the original latent feature.

Entropy maximization Sₑₙₜ seeks to improve the informativeness of the generated image, so Sₑₙₜ=Entropy(s′)—Entropy(s) to encourage the perturbed feature to have higher prediction entropy.

Sample diversity S_{div} is computed by the Kullback-Leibler (KL) divergence among all perturbed latent features of input dataset (x, y): S_{div}=KL(f′; \dot{f}), where f′ denotes a current perturbed latent feature and \dot{f} indicates the mean over the K perturbed latent features of input dataset (x, y).

Worth repeating is that the synthetic images generated in accordance with the non-limiting example embodiments described, recited, and suggested herein are based on guided latent feature optimization. That is, after updating noise z′ and bias b′ for each latent feature vector, GIF obtains a set of new latent features utilizing equation (1), listed above, which may then be used to create new samples through the decoder 120. Thus, a small-scale dataset may be effectively expanded to a larger and more informative one.

Any one or more of a server or cluster of servers upon which media platform 105 is hosted and, therefore, automatic data generation is implemented, may refer to a high-performance computing (HPC) environment that includes, at least, a CPU and GPU that is present on a, e.g., a video card, embedded on a motherboard, or on the CPU die. The training and/or resulting automatic data generation, i.e., dataset expansion, may be executed entirely on the CPU or in part on the CPU and the GPU. Alternative embodiments may be executed in evolved HPC components known in the art. Regardless, the CPU, GPU, and/or HPC components may store one or more algorithms and/or programs that, when executed thereon, may cause the execution or performance of operations and/or functionality as disclosed and/or recited herein. Also, a computer-readable non-volatile medium may be provided according to the embodiments described herein. The computer readable medium stores computer programs. The computer programs are used to, when being executed by a processor, execute or perform the operations or functionality in connection with at least the embodiments described and recited herein.

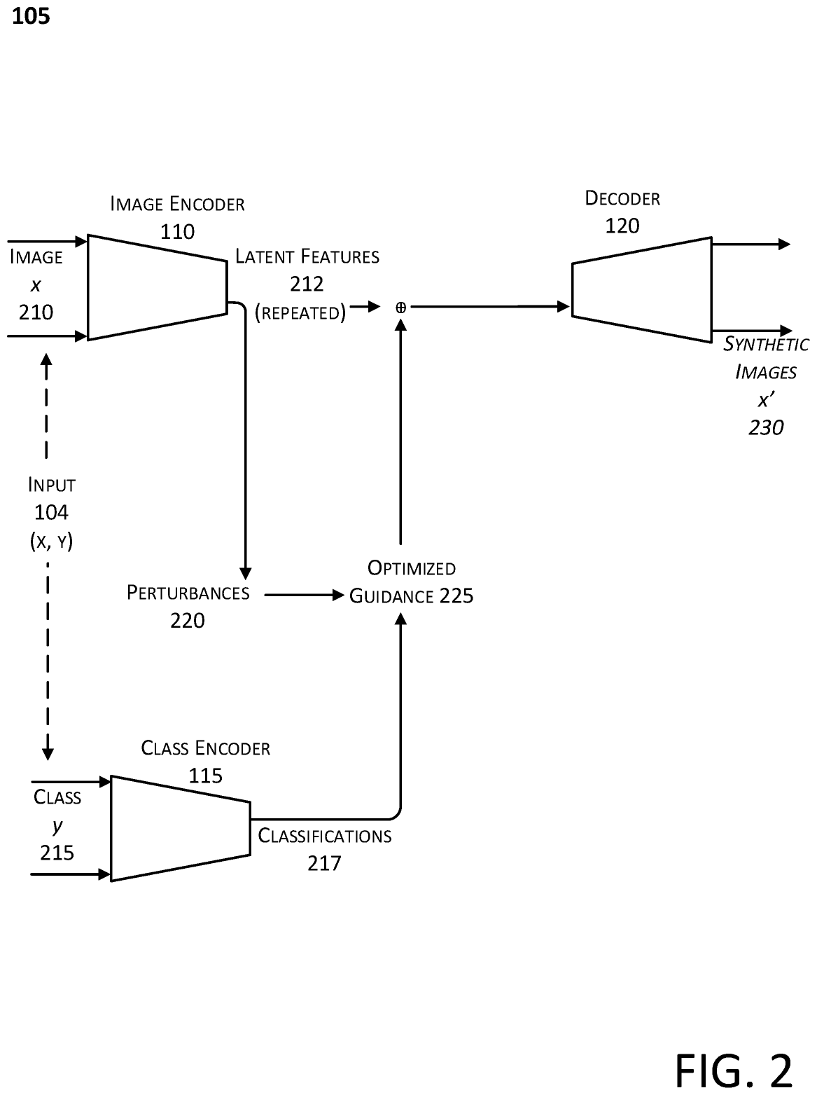

FIG. 2 is a schematic depiction of a portion of media platform 105, arranged in accordance with at least some embodiments of automatic data generation described and recited herein. As depicted, and in accordance with the illustration and description of FIG. 1, media platform 105 includes at least image encoder 110, class encoder 115, and decoder 120. It will also be understood that each storage function and/or operation of the various libraries or storage components may be implemented, individually and/or collectively, by a wide range of hardware, software, firmware, or any combination thereof.

As set forth above, the use of the same reference numbers in different figures indicates similar or identical items. Thus, the description of FIG. 2 incorporates that of FIG. 1.

In accordance with the non-limiting example embodiment of FIGS. 1 and 2, given a pre-trained generative model implemented among image encoder 110, class encoder 115, and decoder 120, input dataset (x, y) 104 received from device 102 is expanded by a factor of K so as to train image generator 125.

Image encoder 110 extracts, from input dataset (x, y) 104, latent feature vectors 212 corresponding to image x 210; and class encoder 115 extracts, from input dataset (x, y) 104, classifications 217 corresponding to class y 215.

Per the pre-trained generative model, e.g., text-visual contrastive pre-training model (CLIP), latent feature vectors 212 are repeated K times, with K being the expansion factor, i.e., an intended number of generated synthetic images based on input dataset (x, y) 104.

The synthetic images, x′, are generated as x′=G(f(x)+δ). G is the pre-trained generative model, f(⋅) refers to image encoder 110, and δ is a perturbation applied to the output latent feature vectors f(x) 212.

The classifications 217 and extracted latent features 212, in addition to being repeated by a factor of K, are perturbed 220 with random noise and bias that are optimized 225 to maintain classification consistency, to increase prediction entropy, and to promote diversity for subsequent images.

Latent feature vectors 212, injected with optimized guidance 225, are then output by decoder 120 as synthetic images 230.

As previously stated herein, having a sufficient amount of training data is needed to optimally utilize deep neural networks (DNN), as intended. However, previous solutions for actually collecting large-scale datasets is expensive and time-consuming. As a result, DNNs have been underutilized. However, by the solutions described, recited, and suggested herein, an input dataset is expanded by a factor of K, thus producing synthetic images, based on latent semantics and true to input classifications, which may then be utilized to train DNN output engines. Accordingly, the present solutions are able to, among multiple advantages, conserve resources for the actual training of and output from a DNN.

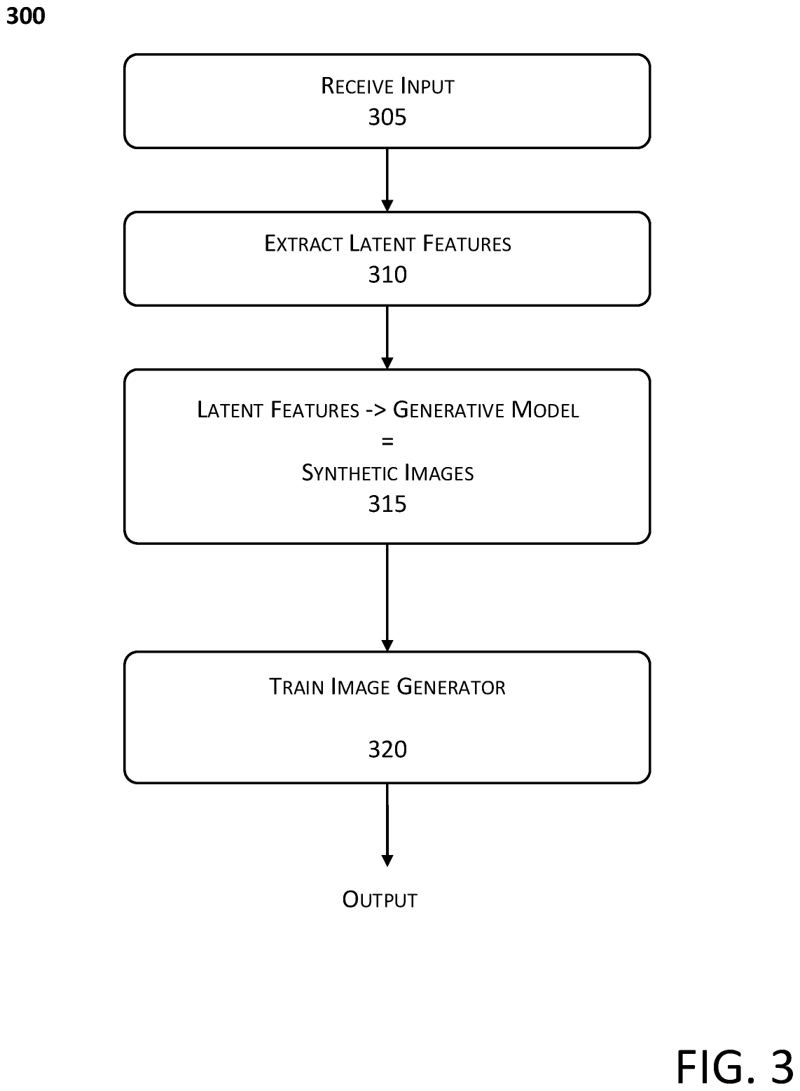

FIG. 3 shows an example processing flow for implementation of automatic data generation, in accordance with at least the embodiments of FIGS. 1 and 2, described and recited herein. As depicted, processing flow 300 includes operations or sub-processes executed by various components of system 100 including media platform 105, as shown and described in connection with FIGS. 1 and 2. However, processing flow 300 is not limited to such components and processes, as obvious modifications may be made by re-ordering two or more of the sub-processes described here, eliminating at least one of the sub-processes, adding further sub-processes, substituting components, or even having various components assuming sub-processing roles accorded to other components in the following description.

Processing flow 300 may include various operations, functions, or actions as illustrated by one or more of blocks 305, 310, 315, and 320. These various operations, functions, or actions may, for example, correspond to software, program code, or program instructions executable by a processor that causes the functions to be performed. Processing may begin at block 305.

At block 305 (receive input), input dataset (x, y) may be received or otherwise input at media platform 105. Processing may proceed to block 310.

At block 310 (extract latent features), image encoder 110 extracts, from input dataset (x, y) 104, latent feature vectors 212 corresponding to image x 210; and class encoder 115 extracts, from input dataset (x, y) 104, classifications 217 corresponding to class y 215. By the pre-trained generative model, e.g., CLIP model, latent feature vectors 212 are repeated by an expansion factor of K. The extracted latent features are perturbed with random noise and bias that are optimized to maintain classification consistency, to increase prediction entropy, and to promote diversity for subsequent images. Processing may proceed to block 315.

At block 315 (generate synthetic images), synthetic images, x′, are generated as x′=G(f(x)+δ). G is the pre-trained generative model, f(⋅) refers to image encoder 110, and δ is the perturbation applied to the output latent feature vectors f(x) 212. Processing may proceed to block 320.

At block 320 (train image generator), a DNN image generator is trained based on the generated synthetic images, which are based on the extracted latent semantics that are perturbed and optimized as described herein, and classifications of the input image.

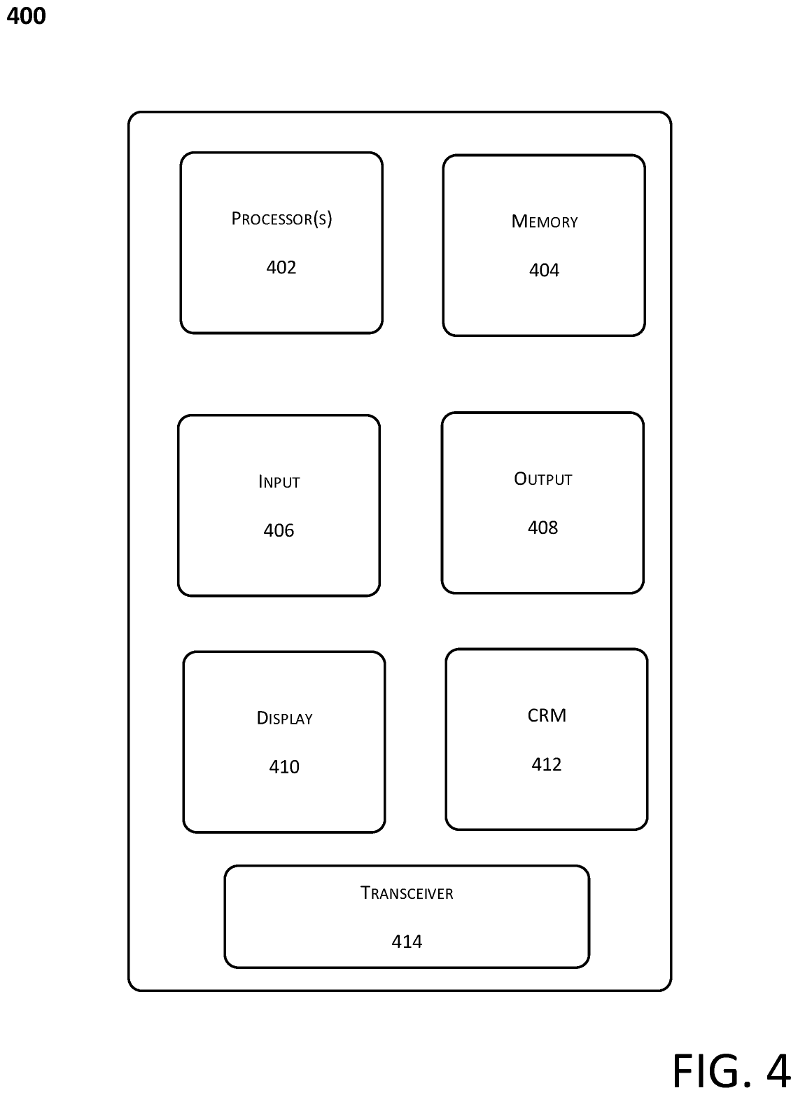

FIG. 4 shows an illustrative computing embodiment, in which any of the processes and sub-processes of automatically generating data may be implemented as executable instructions stored on a non-volatile computer-readable medium. The computer-readable instructions may, for example, be executed by a processor of a device, as referenced herein, having a network element and/or any other device corresponding thereto, particularly as applicable to the applications and/or programs described above corresponding to system 100 to implement automatic data generation.

In a very basic configuration, a computing device 400 may typically include, at least, one or more processors 402, a memory 404, one or more input components 406, one or more output components 408, a display component 410, a computer-readable medium 412, and a transceiver 414.

Processor 402 may refer to, e.g., a microprocessor, a microcontroller, a digital signal processor, or any combination thereof.

Memory 404 may refer to, e.g., a volatile memory, non-volatile memory, or any combination thereof. Memory 404 may store, therein, an operating system, one or more applications corresponding to media platform 105 and/or program data therefore. That is, memory 404 may store executable instructions to implement any of the functions or operations described above and, therefore, memory 404 may be regarded as a computer-readable medium.

Input component 406 may refer to a built-in or communicatively coupled keyboard, touch screen, telecommunication device, i.e., smartphone, and/or a microphone that is configured, in cooperation with a voice-recognition program that may be stored in memory 404, to receive voice commands from a user of computing device 400. Further, input component 406, if not built-in to computing device 400, may be communicatively coupled thereto via short-range communication protocols including, but not limitation, radio frequency or Bluetooth®.

Output component 408 may refer to a component or module, built-in or removable from computing device 400, that is configured to output commands and data to an external device.

Display component 410 may refer to, e.g., a solid state display that may have touch input capabilities. That is, display component 410 may include capabilities that may be shared with or replace those of input component 406.

Computer-readable medium 412 may refer to a separable machine-readable medium that is configured to store one or more programs that embody any of the functions or operations described above. That is, computer-readable medium 412, which may be received into or otherwise connected to a drive component of computing device 400, may store executable instructions to implement any of the functions or operations described above. These instructions may be complimentary or otherwise independent of those stored by memory 404.

Transceiver 414 may refer to a network communication link for computing device 400, configured as a wired network or direct-wired connection. Alternatively, transceiver 414 may be configured as a wireless connection, e.g., radio frequency (RF), infrared, Bluetooth®, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

### Aspects

Aspect 1. A media platform, comprising:
an image extractor to extract latent features and at least one class from an input image;
a generative model to:
   generate synthetic images based on the extracted latent features, the synthetic images having a same class as the input image and
   train a deep neural network (DNN) image generating model using the generated synthetic images; and
a DNN image generator to generate images utilizing the DNN image generating model.

Aspect 2. The media platform of Aspect 1, wherein the extracted latent features are perturbed with random noise and bias that are optimized to maintain classification consistency, to increase prediction entropy, and to promote diversity for subsequent images.

Aspect 3. The media platform of either of Aspect 1 or Aspect 2, wherein the media platform is a social media platform.

Aspect 4. The media platform of any of Aspect 1-3, wherein the DNN image generator is to generate memes for the social media platform.

Aspect 5. The media platform of any of Aspects 1-3, wherein the media platform is a video security platform.

Aspect 6. The media platform of any of Aspects 1-3 or 5, wherein the DNN image generator is to generate images for an object detection model.

Aspect 7. A method of automatic data generation, comprising:
extracting latent features and at least one classification from an input image;
inputting the extracted latent features into a generative model decoder; and
generating synthetic images using a large-scale generative model.

Aspect 8. The method of Aspect 7, wherein the synthetic images x′ are generated as:

x′=G(f(x)+δ),
wherein:
   (x, y) is a sample of the extracted latent features,
      x is an input image and y is a classification,
   G is the pre-trained generative model,
   f(⋅) is an image encoder of the generative model, and
   δ is a perturbation applied to f(x).

Aspect 9. The method of Aspect 7 or Aspect 8, wherein the extracted latent features are perturbed with random noise and bias that are optimized to maintain classification consistency, to increase prediction entropy, and to promote diversity for subsequent images.

Aspect 10. The method of Aspect 8 or Aspect 9, wherein δ is a random noise sampled from a Gaussian distribution.

Aspect 11. The method of any of Aspects 7-10, wherein the extracting is performed by a text-visual contrastive pre-training model (CLIP).

Aspect 12. The method of any of Aspects 7-11, wherein further f(x) does not change a classification for x.

Aspect 13. The method of any of Aspects 7-12, the generated synthetic images has a same classification y.

Aspect 14. A non-volatile computer-readable medium having computer-executable instructions stored thereon that, upon execution, cause one or more processors to perform operations comprising:
extracting latent features and at least one classification from an input image;
adding a perturbation to the latent features;
decoding the perturbed latent features in accordance with a pre-trained generative model; and
training a deep neural network (DNN) image generator with the decoded images.

Aspect 15. The non-volatile computer-readable medium of Aspect 14, wherein the extracting is executed by a contrastive pre-training model (CLIP) image encoder.

Aspect 16. The non-volatile computer-readable medium of either of Aspect 14 or Aspect 15, wherein the perturbation is a random noise sampled from a Gaussian distribution.

Aspect 17. The non-volatile computer-readable medium of any of Aspects 14-16, wherein the perturbation includes random noise and bias that are optimized to maintain classification consistency, to increase prediction entropy, and to promote diversity for subsequent images.

Aspect 18. The non-volatile computer-readable medium of any of Aspects 14-17, wherein the decoding is executed by a DALL-E2 decoder.

Aspect 19. The computer-readable medium of any of Aspects 14-18, wherein the decoded images have a same classification as the input image.

What is claimed:

1. A media platform, comprising:
an image extractor to extract latent features and at least one class from an input image;
a generative model to:
generate synthetic images based on the extracted latent features, the synthetic images having a same class as the input image and
train a deep neural network (DNN) image generating model using the generated synthetic images; and
a DNN image generator to generate images utilizing the DNN image generating model.

2. The media platform of claim 1, wherein the extracted latent features are perturbed with random noise and bias that are optimized to maintain classification consistency, to increase prediction entropy, and to promote diversity for subsequent images.

3. The media platform of claim 1, wherein the media platform is a social media platform.

4. The media platform of claim 3, wherein the DNN image generator is to generate memes for the social media platform.

5. The media platform of claim 1, wherein the media platform is a video security platform.

6. The media platform of claim 5, wherein the DNN image generator is to generate images for an object detection model.

7. A method of automatic data generation, comprising:
extracting latent features and at least one classification from an input image;
inputting the extracted latent features into a generative model decoder; and
generating synthetic images using a large-scale generative model.

8. The method of claim 7, wherein the synthetic images x′ are generated as:
x′=G(f(x)+δ),
wherein:
(x, y) is a sample of the extracted latent features,
x is an input image and y is the classification,
G is the pre-trained generative model,
f(⋅) is an image encoder of the generative model, and
δ is a perturbation applied to f(x).

9. The method of claim 8, wherein the extracted latent features are perturbed with random noise and bias that are optimized to maintain classification consistency, to increase prediction entropy, and to promote diversity for subsequent images.

10. The method of claim 9, wherein δ is a random noise sampled from a Gaussian distribution.

11. The method of claim 9, wherein the extracting is performed by a text-visual contrastive pre-training model (CLIP) encoder.

12. The method of claim 9, wherein f(x) does not change a classification for x.

13. The method of claim 9, wherein the generated synthetic images have a same classification y.

14. A non-volatile computer-readable medium having computer-executable instructions stored thereon that, upon execution, cause one or more processors to perform operations comprising:
extracting latent features and at least one classification from an input image;
adding a perturbation to the latent features;
decoding the perturbed latent features in accordance with a pre-trained generative model; and
training a deep neural network (DNN) image generator with the decoded images.

15. The non-volatile computer-readable medium of claim 14, wherein the extracting is executed by a contrastive pre-training model (CLIP) image encoder.

16. The non-volatile computer-readable medium of claim 14, wherein the perturbation is a random noise sampled from a Gaussian distribution.

17. The non-volatile computer-readable medium of claim 16, wherein the perturbation includes random noise and bias that are optimized to maintain classification consistency, to increase prediction entropy, and to promote diversity for subsequent images.

18. The non-volatile computer-readable medium of claim 16, wherein the decoding is executed by a DALL-E2 decoder.

19. The non-volatile computer-readable medium of claim 14, wherein the decoded images have a same classification as the input image.
